(19) United States
(12) Patent Application Publication
(10) Pub. No.: US 2024/0230589 A1
(43) Pub. Date: Jul. 11, 2024

(54) CAPILLARY ELECTROPHORESIS DEVICE

(71) Applicant: HITACHI HIGH-TECH CORPORATION, Tokyo (JP)

(72) Inventors: Kentaro Osawa, Tokyo (JP); Takashi Anazawa, Tokyo (JP)

(73) Assignee: HITACHI HIGH-TECH CORPORATION, Tokyo (JP)

(21) Appl. No.: 18/558,773

(22) PCT Filed: Jun. 30, 2021
(86) PCT No.: PCT/JP2021/024859

§ 371 Date: Nov. 3, 2023

(51) Int. Cl. G01N 27/447; G01N 21/64

(52) U.S. Cl. CPC G01N 27/44721; G01N 21/645; G01N 2021/6484

(57) ABSTRACT

A capillary electrophoresis device includes: a light source; a plurality of capillaries; a light detection unit; and a plurality of detection optical fibers each having one end face disposed in association with corresponding one of the capillaries and another end face connected to the light detection unit, wherein the light detection unit selectively detects light in a central portion of the detection optical fiber.

### TECHNICAL FIELD

The present invention relates to a capillary electrophoresis device.

### BACKGROUND ART

Biopharmaceuticals include glycosylated antibody molecules working on a specific target, such as cancer or rare disease, and this is an excellent effect not found in small molecule pharmaceuticals. While small molecule pharmaceuticals are synthesized by chemical reactions, biopharmaceuticals are produced by taking advantage of the biological functions of cells. Therefore, slight changes in culture conditions affect the molecular structure of the product. Immunoglobulin G (IgG), which is a representative biopharmaceutical product, has large molecules with a complicated structure and a molecular weight of about 150,000, and it is almost impossible to prevent heterogeneity in its structure. Therefore, quality inspection techniques for checking the safety and the efficacy of the biopharmaceutical preparation process play an even more important role.

Because a target material has a complicated structure, a broad range of inspection items is involved in inspecting biopharmaceuticals. In tests for confirming that a substance under inspection contains the target material as a main component, or purity tests for evaluating the amount of impurity content, for example, capillary electrophoresis is used. A capillary electrophoresis device injects a sample such as an antibody into a capillary, subjects the sample to electrophoresis to separate the sample into molecules based on their molecular weights or electric charges, and detects the separated molecules using a detector provided near the capillary terminal. As the detection methods, optical methods such as ultraviolet (UV) absorption, native fluorescence (NF) detection, or Laser Induced Fluorescence (LIF) are in wide use.

An example of such a capillary electrophoresis device is disclosed in PTL 1.

The LIF measurement is the most sensitive among these detection techniques, and has been put in use for a long time for applications such as detections of molecules that are difficult to detect with UV absorption or NF detection, e.g., glycans in antibody drugs, or detections of nucleic acids such as DNA. Because the LIF measurement uses a laser as a light source, by making use of the directivity of the laser and the lens effect of the capillary, a plurality of capillaries can be irradiated simultaneously with the laser. As a result, a plurality of samples can be analyzed at a time, and high-throughput analysis can be achieved.

### CITATION LIST

### Patent Literature

PTL 1: JP 2016-133373 A

### SUMMARY OF INVENTION

### Technical Problem

While the LIF measurement is capable of making analysis of a plurality of capillaries simultaneously, the size of the device tends to be large, because a plurality of lenses or a large lens covering the plurality of capillaries is required to detect fluorescence generated from the plurality of capillaries. To overcome this challenge, the inventors of the present invention have developed an optical system in which fibers are disposed in proximity of respective capillaries to collect the fluorescence therefrom. With this optical system, fluorescence can be detected without disposing any lens near the capillaries. Therefore, the limitation in the positional relationship between the capillaries and the detector is eliminated, and the degree of freedom in the design is improved, so that downsizing of the device becomes possible.

However, this detection optical system has a disadvantage that fluorescence generated from a specific capillary becomes incident on a fiber corresponding to another capillary adjacent thereto, and crosstalk becomes prominent.

The present invention has been made in consideration of the above problems, and an object of the present invention is to provide a small capillary electrophoresis device with lower crosstalk.

### Solution to Problem

One example of a capillary electrophoresis device according to the present invention includes:
a light source;
a plurality of capillaries;
a light detection unit; and
a plurality of detection optical fibers each having one end face disposed in association with corresponding one of the capillaries and another end face connected to the light detection unit,
wherein the light detection unit selectively detects light in a central portion of the detection optical fiber.

### Advantageous Effects of Invention

According to the present invention, it is possible to provide a capillary electrophoresis device smaller in size and exhibiting lower crosstalk, in comparison with a conventional capillary electrophoresis device. Furthermore, in some cases, it is possible to provide a capillary electrophoresis device less expensive than the conventional capillary electrophoresis device.

Problems, configurations, and advantageous effects other than those explained above will become clear in the following description of the embodiment.

### BRIEF DESCRIPTION OF DRAWINGS

FIG. 1 is a schematic diagram illustrating a configuration example of a capillary electrophoresis device according to a first embodiment of the present invention.

FIG. 2 is a schematic diagram illustrating a configuration example of a component detector of the capillary electrophoresis device of FIG. 1.

FIG. 3 is a schematic diagram illustrating a mechanism by which crosstalk occurs.

FIG. 4 is an example of a light intensity distribution on an emitting end of a detection optical fiber.

FIG. 5 is an example of simulation results of signal strength and crosstalk in the first embodiment.

FIG. 6 is a simulation result regarding propagation efficiency of an optical fiber and incident angle dependency of a light intensity distribution on the emitting end.

FIG. 7 is a diagram for explaining an optical path of a light beam becoming incident on the optical fiber.

FIG. 8 is a calculation result of incident angle dependency of propagation efficiency of the optical fiber.

FIG. 9 is a schematic of a ray diagram of a light beam propagating through the optical fiber.

FIG. 10 is a calculation result of a radius of an area with a zero light intensity distribution after the propagation of an optical fiber.

FIG. 11 is a schematic diagram illustrating a configuration example of a component detector of a capillary electrophoresis device according to a second embodiment of the present invention.

FIG. 12 is a schematic diagram illustrating a configuration example of a component detector of a capillary electrophoresis device according to a third embodiment of the present invention.

FIG. 13 is a schematic diagram illustrating a configuration example of a component detector of a capillary electrophoresis device according to a fourth embodiment of the present invention.

### DESCRIPTION OF EMBODIMENTS

Some embodiment of the present invention will now be explained with reference to drawings.

### First Embodiment

### <Basic Configuration>

### (Description of Overall Electrophoresis Device)

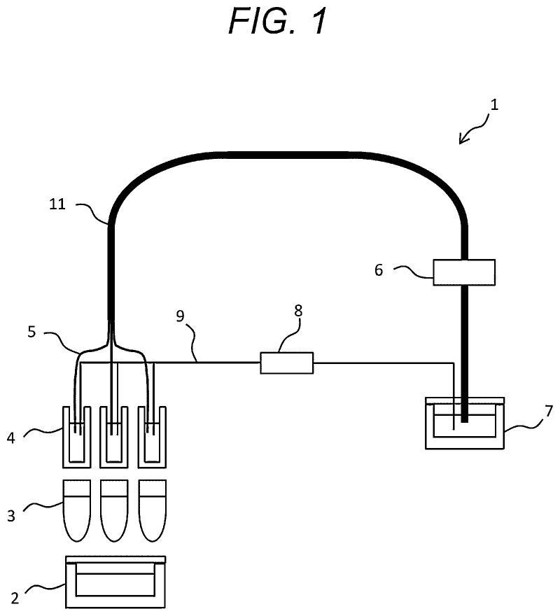

FIG. 1 is a schematic diagram illustrating a configuration example of a capillary electrophoresis device 1 according to the present embodiment. In an electrophoresis medium container 2 and a plurality of sample containers 3, a medium of electrophoresis and samples are stored, respectively. Before carrying out a measurement, a plurality of capillaries 5 included in a capillary array 11 are connected to the respective containers, and the electrophoresis medium and the samples are injected sequentially into the plurality of capillaries 5, by electrical means, pressure, or the like. A plurality of inlet-side electrode vials 4 and an outlet-side electrode vial 7 are filled with a buffer solution, and the capillaries 5 and an electrode 9 are immersed therein during the electrophoresis.

Upon receiving an application of a voltage of a high-voltage power supply 8, the molecules in the samples move from the injection side toward the discharge side along the capillaries 5, while going through electrophoresis and being separated based on their properties, such as molecular weights and electrical charges. Upon reaching the component detector 6, the molecules thus moved are detected by optical means. Although not illustrated, the capillary electrophoresis device 1 also includes a pressure adjusting unit, a control unit, a signal processing unit, a display unit, and a recording unit, for example.

### (Description of Component Detector)

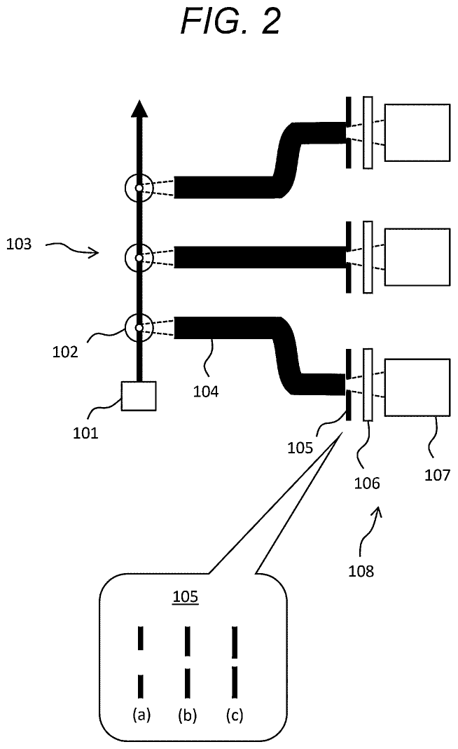

FIG. 2 is a configuration example of the component detector 6 of the electrophoresis device 1. A light source 101 emits excitation light toward the plurality of capillaries 102 in the direction in which the capillary array 103 is arranged. In this manner, it is possible to irradiate the plurality of capillaries 102 with excitation light, using one light source 101.

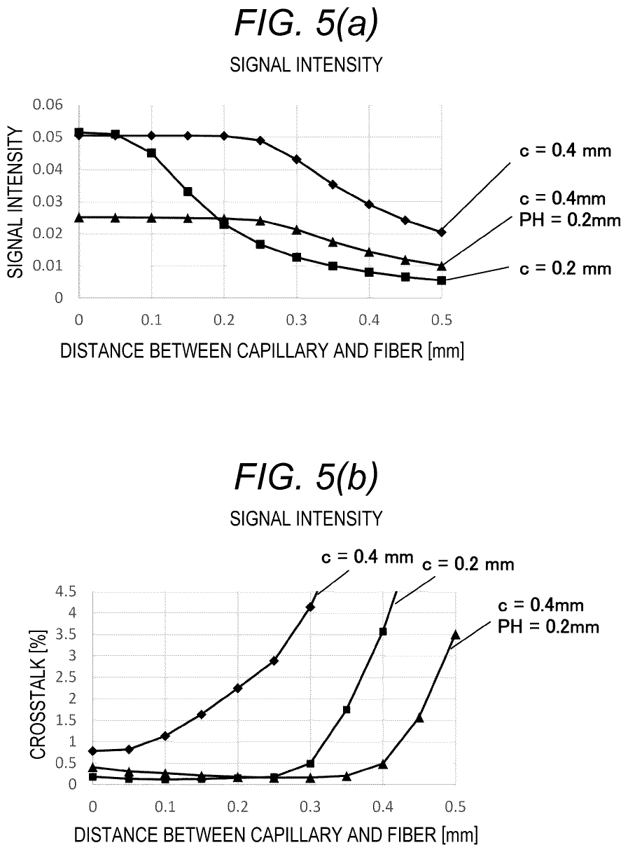

The component detector 6 includes a plurality of detection optical fibers 104. The detection optical fibers 104 correspond to the respective capillaries 102. Each of the detection optical fibers 104 has one end face disposed in association with the corresponding capillary 102, e.g., disposed in proximity of the corresponding capillary 102. A specific range of the “proximity” can be determined by those skilled in the art as appropriate, considering matters to be described later with reference to FIG. 5, and may be one of the ranges indicated in FIG. 5. (e.g., 0.1 mm or less, 0.2 mm or less, 0.3 mm or less, 0.4 mm or less, or 0.5 mm or less, but greater than 0), for example. The other end face of the detection optical fiber 104 is connected to the light detection unit 108.

When the samples in the capillaries 102 are irradiated with the excitation light, the samples emit fluorescence (autofluorescence or fluorescence from a fluorescent dye), and a part of the fluorescence is coupled to the detection optical fiber 104 provided correspondingly to each of the capillaries 102. The fluorescence propagates through the detection optical fiber 104 and is guided into the light detection unit 108 that includes a pinhole 105, a longpass filter 106, and a photodetector 107.

When the fluorescence goes out of the detection optical fiber 104 and into the space, the pinhole 105 provided on the emitting end of each of the detection optical fibers 104 shields the fluorescence around the periphery of the detection optical fiber 104, and only the fluorescence near a central portion is emitted into the space. The fluorescence is then transmitted through the longpass filter 106, and then detected by the photodetector 107.

In the manner described above, the pinhole 105 functions as a selective light shielding element, and allows the light detection unit 108 to detect the light selectively at the central portion of the detection optical fiber 104. The “central portion of the detection optical fiber 104” herein means an area including the central axis of the detection optical fiber in a cross section orthogonal to the central axis, for example, and specifically means a disk area having the center at the central axis. The radius of the disk area may be determined by those skilled in the art, as appropriate, in consideration of matters such as those described later with reference to FIG. 5.

The longpass filter 106 is installed to prevent detection of the excitation light having been scattered by the capillary 102 to be coupled to the detection optical fiber 104.

Crosstalk occurs when the fluorescence emitted from a specific capillary 102 becomes coupled to detection optical fibers 104 other than the corresponding detection optical fiber 104, and the pinhole 105 plays the role of suppressing such crosstalk between the capillaries.

As illustrated in the balloon of FIG. 2, at least one of the area and the shape of the opening of the pinhole 105 (that is a selectively detected area of the detection optical fiber 104) may be configured changeable. For example, a plurality of pinholes having openings with different dimensions or shapes, as illustrated in (a), (b), and (c) of FIGS. 2, may be replaced with one another, or one pinhole may be enabled to change the dimension or the shape of the opening, as illustrated in (a), (b), and (c). With such a configuration, as will be described later, it is possible to adjust the balance between loss suppression of a signal component and crosstalk blocking. Note that, in the other embodiments to be described later, the selectively detected area of the detection optical fiber 104 may be changed in the same manner.

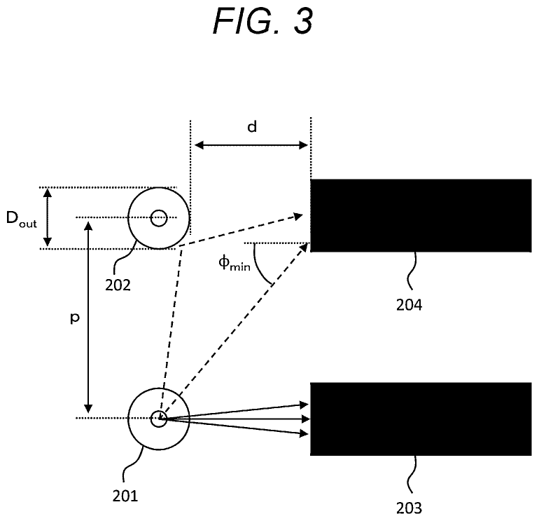

FIG. 3 is a diagram illustrating an example of the mechanism by which the crosstalk occurs. The fluorescence emitted from each of the capillaries 201 becomes incident on the corresponding detection optical fiber 203 (solid arrows), and is detected as a signal component. At the same time, the light also becomes incident on a detection optical fiber 204 corresponding to an adjacent capillary 202, directly, or indirectly by being reflected on the capillary 202 (dashed arrows), and is detected as crosstalk components. As illustrated in the drawing, a crosstalk component tends to become incident on the fiber at a greater incident angle than the signal component.

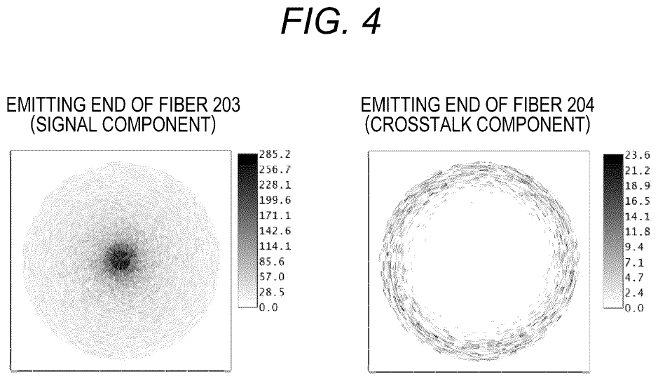

FIG. 4 is intensity distributions on the emitting ends of the detection optical fibers 203, 204, respectively, each resultant of running a beam-tracing simulation of the fluorescence having been generated in the capillaries 201, having become coupled to, and propagated through the detection optical fibers. As simulation conditions, the inner diameter of the capillaries was set to 50 μm; the outer diameter of the capillaries was set to 150 μm; the distance between the capillaries was set to 500 μm; and the distance from the capillary surface to the incoming end of the corresponding detection optical fiber was set to 300 μm. The detection optical fibers 203, 204 were multimode fibers, and each had a core diameter of 400 μm, a cladding diameter of 420 μm, a numerical aperture of 0.5, and a length of 100 mm. The fluorescence emission region of the capillary 201 had a cylindrical shape with a diameter of 50 μm and a height of 50 μm.

While the drawings illustrate how the light intensity of the signal component tends to be localized at the center of the fiber, on the emitting end of the detection optical fiber 203, the light intensity of the crosstalk component tends to be localized around the periphery of the fiber, on the emitting end of the detection optical fiber 204. These intensity distributions reflect the nature of a multimode fiber, where light incident on the fiber at a smaller incident angle is localized at the center of the fiber, and the light incident at a greater incident angle is localized around the periphery. Taking advantage of this nature of the optical fiber, in the present embodiment, the crosstalk can be suppressed by using the pinhole 105, so that the light from the central portion of the detection optical fiber 104 is detected selectively.

FIG. 5 illustrates a simulated evaluation result of the effect of suppressing crosstalk in the present embodiment. The graphs indicate how the signal intensity and the crosstalk have a dependency on the distance between the capillary and the fiber, using detection optical fibers having core diameters c of 400 μm and 200 μm, respectively, as reference examples, and another fiber having a core diameter of 400 μm and having an emitting end provided with a pinhole having a hole diameter PH of 200 μm, as a specific configuration of the present embodiment.

The other simulation conditions are the same as those in the example of FIG. 4. When the core diameter c is increased, the signal intensity as well as the crosstalk also increase.

When the distance between the capillary and fiber is reduced, the signal intensity increases and the crosstalk decreases. Therefore, it is preferable to make the distance between the capillary and the fiber as small as possible. However, if the distance is too short, the fiber and the capillary are brought into contact with each other, and the risk of damage increases. Therefore, in practice, it is preferable to separate the fiber and the capillary by a distance of several hundred microns or more.

For example, when the distance between the capillary and the fiber is 200 μm or more, the fiber with a core diameter of 400 μm experiences a high crosstalk of about 2.2% or more. The fiber having a core diameter of 200 μm exhibits a signal intensity lower than that of the fiber with a core diameter of 400 μm, but the crosstalk is even lower. When the distance between the fiber capillary is 0.3 mm or less, the resultant crosstalk is kept 0.5% or less.

When a 200 μm pinhole is provided on the emitting end of the fiber having a core diameter of 400 μm, in the specific configuration according to the present embodiment, the fiber exhibits higher signal intensity and crosstalk equal to or lower than that in the fiber with a core diameter of 200 μm, when the distance between the fiber and the capillary is set to 200 μm or more. These results means that, under the condition where the capillary is separated from the fiber by some distance, it may be more advantageous, from the viewpoints of both signal intensity and crosstalk, to provide a pinhole to the emitting end of a fiber having a large core diameter, as in the present embodiment, than to simply use a fiber having a small core diameter.

In comparison with the reference example with a core diameter of 400 μm, in the present embodiment in which the 200 μm pinhole is provided on the emitting end with the core diameter of 400 μm, the signal intensity decreases to about a half, while the crosstalk has gone down from 4.13% to 0.16%, which is about 1/26. This result indicates that the pinhole effectively shields a greater amount of the crosstalk component more than the amount of the signal component.

Although crosstalk can be suppressed by optimizing the core diameter and the numerical aperture of the fiber, the core diameter and the numerical aperture of fibers that are commercially available are often limited, and the degree of freedom in the optimization is extremely low. By contrast, the hole diameter of the pinhole can be set freely. Therefore, the degree of freedom in the optimization is high in the present embodiment.

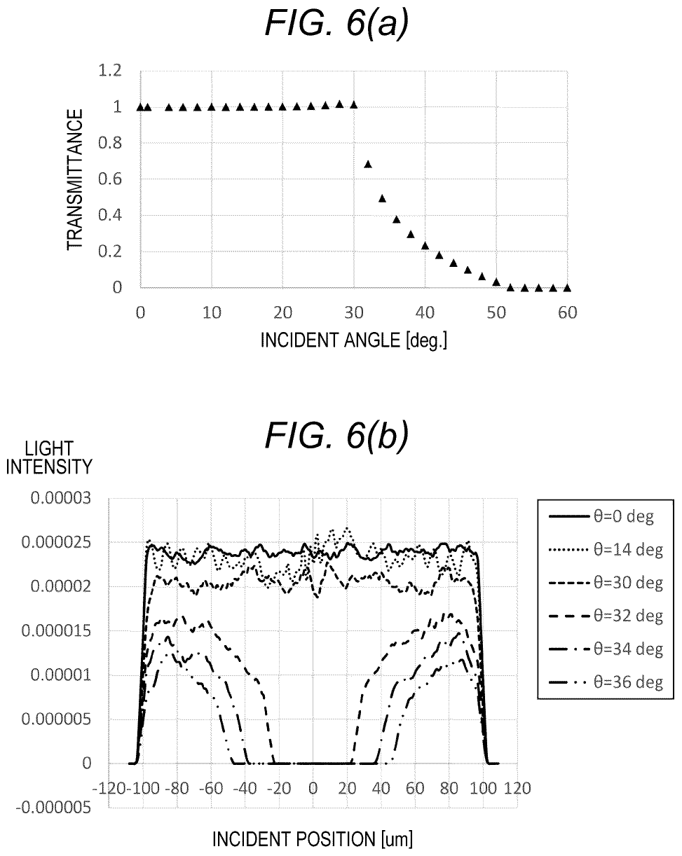

An operation principle and an appropriate size of the light shielding area according to the present embodiment will be described in detail, based on simulations and mathematical expressions. FIG. 6(a) is a simulation result of the dependency of the light propagation efficiency of the fiber on the incident angle of the light (the ratio of the light reaching the emitting end of the fiber with respect to the incident light).

The simulation was carried out using a multimode fiber, having a core diameter of 200 μm, a cladding diameter of 220 μm, a numerical aperture of 0.5, and a length of 100 mm. The light propagation efficiency is almost 1 up to an incident angle of 30 degrees corresponding to the numerical aperture of the fiber, and rapidly decreases as the incident angle exceeds 30 degrees. This is because, when the incident angle exceeds 30 degrees, components not satisfying the condition for the total reflection condition of the fiber increase.

FIG. 6(b) illustrates light intensity distributions of the light on the emitting end of the fiber for respective incident angles. It can be seen that generally uniform intensity distributions are exhibited at incident angles up to 30 degrees, but the light is localized around the peripheral portion with incident angles exceeding 30 degrees. In other words, the intensity of light incident at an angle greater than the angle corresponding to the numerical aperture of the fiber tends to be localized around the periphery of the fiber.

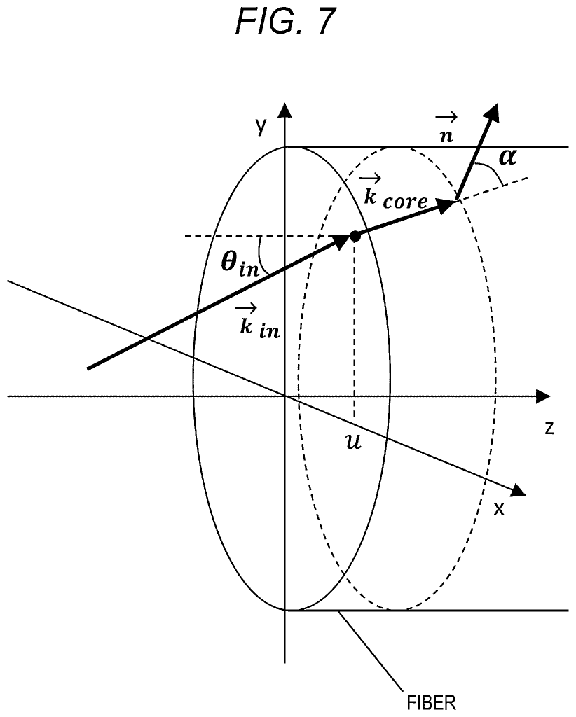

A principle by which the fiber exhibits such a property will now be described with reference to some drawings. As illustrated in FIG. 7, let us now assume a coordinate system in which the point of origin is at the center of the incoming end of the fiber. The z-axis corresponds to the central axis of the fiber. The x-axis and the y-axis are axes orthogonal to each other in the radial direction of the fiber.

Considered herein is a light beam incident on the fiber at an incident angle θᵢₙ. A unit direction vector kᵢₙ of the incident light beam and a unit direction vector k_{c0re} of the light beam immediately after being refracted on the fiber surface are expressed as following mathematical expressions, respectively.

$$\begin{matrix}[ Mathematical expression 1 ] & \\ \vec{{k}_{in}} = ( \begin{matrix}0 \\ sin {θ}_{in} \\ cos {θ}_{in}\end{matrix} ) & ( Mathematical expression 1 )\end{matrix}$$

$$\begin{matrix}[ Mathematical expression 2 ] & \\ \vec{{k}_{core}} = ( \begin{matrix}0 \\ sin {θ}_{core} \\ cos {θ}_{core}\end{matrix} ) & ( Mathematical expression 2 )\end{matrix}$$

At this time, θᵢₙ and e_{c0re} satisfy the following relationship, based on the Snell's law.

$$\begin{matrix}[ Mathematical expression 3 ] & \\ sin {θ}_{in} = {n}_{core} sin {θ}_{core} & ( Mathematical expression 3 )\end{matrix}$$

Where n_{c0re} is the refractive index of the fiber core. The x coordinate of the position at which the light beam becomes incident on the incoming end of the fiber is expressed by uc/2, using a real number u satisfying −1<u<1 and the core diameter c of the fiber. At this time, a normal vector n with respect to the interface between the core and the cladding at the position where the incident light beam becomes incident on the interface between the core and the cladding is expressed by the following mathematical expression.

$$\begin{matrix}[ Mathematical expression 4 ] & \\ \vec{n} = ( \begin{matrix}u \\ \sqrt{1 - {u}^{2}} \\ 0\end{matrix} ) & ( Mathematical expression 4 )\end{matrix}$$

The incident angle α of the light beam on the interface between the core and the cladding is determined by the following mathematical expression.

$$\begin{matrix}[ Mathematical expression 5 ] & \\ cos α = \vec{{k}_{core}} \cdot \vec{n} = \sqrt{1 - {u}^{2}} sin {θ}_{core} & ( Mathematical expression 5 )\end{matrix}$$

The condition for the light beam to go through the total reflection on the interface between the core and the cladding is as follows.

$$\begin{matrix}[ Mathematical expression 6 ] & \\ {n}_{core} sin α > {n}_{clad} & ( Mathematical expression 6 )\end{matrix}$$

Using Mathematical Expressions 3 and 5, Mathematical Expression 6 can be rewritten as follows.

$$\begin{matrix}[ Mathematical expression 7 ] & \\ sin {θ}_{in} < \sqrt{\frac{{n}_{core}^{2} - {n}_{clad}^{2}}{1 - {u}^{2}}} & ( Mathematical expression 7 )\end{matrix}$$

Furthermore, considering that the numerical aperture NA of the fiber is given by:

$$\begin{matrix}[ Mathematical expression 8 ] & \\ NA = \sqrt{{n}_{core}^{2} - {n}_{clad}^{2}} , & ( Mathematical expression 8 )\end{matrix}$$

the condition for the total reflection of the light beam is finally expressed by the following mathematical expression.

$$\begin{matrix}[ Mathematical expression 9 ] & \\ sin {θ}_{in} < \frac{NA}{\sqrt{1 - {u}^{2}}} & ( Mathematical expression 9 )\end{matrix}$$

Mathematical Expression 9 indicates that when the position x at which the light beam becomes incident is closer to the periphery of the fiber (when the absolute value of u is larger), a wider range of light beam angles satisfies the total reflection condition.

The following mathematical expression defines the upper limit θ_{c0} of the incident angle satisfying the total reflection condition when the light beam becomes incident at the position u=0 (the incident angle corresponding to the NA of the fiber).

$$\begin{matrix}[ Mathematical expression 10 ] & \\ sin {θ}_{c 0} = NA & ( Matematical expression 10 )\end{matrix}$$

The light beam having an incident angle of θ_{c0} or less satisfies the total reflection condition regardless of the position x of the incidence, but the light beam incident at the angle of θ_{c0} or more satisfies the total reflection condition when the light beam becomes incident at a position away from the center by a certain distance. Solving Mathematical Expression 8 for u yields the following mathematical expression:

$$\begin{matrix}[ Mathematical expression 11 ] & \\ u > {u}_{c} & ( Mathematical expression 11 )\end{matrix}$$

where

$$\begin{matrix}[ Mathematical expression 12 ] & \\ {u}_{c} = \sqrt{1 - {( \frac{NA}{sin {θ}_{in}} )}^{2}} ( \vert {θ}_{in} \vert > \vert {θ}_{c 0} \vert ) & ( Mathematical expression 12 )\end{matrix}$$

The light beam incident at an angle of θ_{c0} or more satisfies the total reflection condition only when the absolute value of the x-axis position at which the light beam becomes incident on the fiber is u_{c}c/2 or more. The propagation efficiency P of the fiber for the light beam being incident at the incident angle θ_{c0} or more is determined by an area of incident positions satisfying the total reflection condition in the fiber, and is given by the following mathematical expression.

$$\begin{matrix}[ Mathematical expression 13 ] & \\ P = \frac{1}{π} ( π - 4 {\int }_{0}^{{u}_{c}} \sqrt{1 - {u}^{2}} du ) & ( Mathematical expression 13 )\end{matrix}$$

The following mathematical expression is obtained as an integration of Mathematical Expression 13.

$$\begin{matrix}[ Mathematical expression 14 ] & \\ P = \frac{1}{π} ( π - 2 {u}_{c} \sqrt{1 - {u}_{c}^{2}} - 2 {sin}^{- 1} {u}_{c} ) & ( Mathematical expression 14 )\end{matrix}$$

When Mathematical Expression 12 is substituted into Mathematical Expression 14 and considering that any light beams becoming incident at the incident angle θ_{c0} or less satisfy the total reflection condition, the propagation efficiency P for the light beam at incident angle θᵢₙ can be expressed as the following mathematical expression.

$$\begin{matrix}[ Mathematical expression 15 ] & \\ P = \{ \begin{matrix}1 & ( \vert {θ}_{in} \vert < \vert {θ}_{c 0} \vert ) \\ \frac{1}{π} ( π - 2 \sqrt{1 - {( \frac{NA}{sin {θ}_{in}} )}^{2}} ( \frac{NA}{sin {θ}_{in}} ) - 2 {sin}^{- 1} ( \frac{NA}{sin {θ}_{in}} ) ) & ( \vert {θ}_{in} \vert > \vert {θ}_{c 0} \vert )\end{matrix} & ( Mathematical expression 15 )\end{matrix}$$

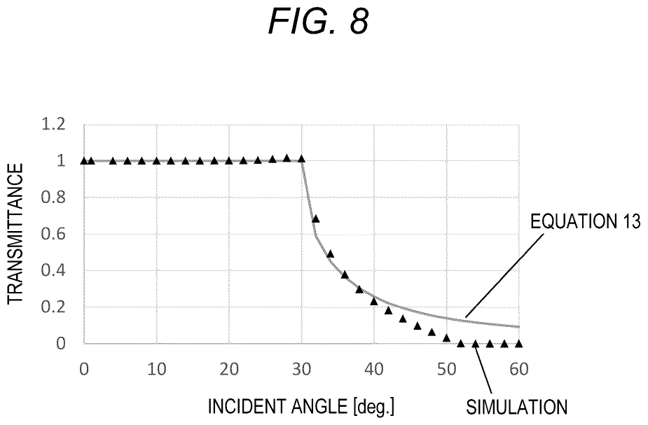

FIG. 8 is a comparison of the propagation efficiency expressed by Mathematical Expression 13, with the results of the beam-tracing simulation illustrated in FIG. 6. These two match with each other qualitatively, and it can be seen that the theory related to the dependency of the fiber propagation efficiency on the incident angle, as described above, holds valid.

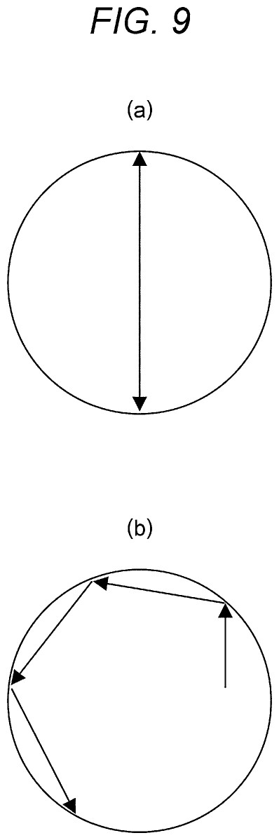

FIG. 9 is a schematic diagram of a trajectory of a light beam propagating along a fiber as viewed from the side of the incoming end of the fiber. FIG. 9(a) illustrates an example in which the x incident position of the light beam on the fiber is at the center (u=0), and FIG. 9(b) illustrates an example in which the x incident position of the light beam on the fiber is on the periphery (u>0). As illustrated in FIG. 9(a), the light beam having become incident on the center is reflected on the same positions repeatedly, and passes through the center of the fiber every time the light beam is reflected. By contrast, as illustrated in FIG. 9(b), the light beam having become incident on the periphery of the fiber only propagates along the periphery of the fiber, without passing through the center of the fiber, because the light beam becomes incident on the interface between the core and the cladding at a greater incident angle.

From the above results, it can be seen that the light beam incident on the fiber at the angle corresponding to the NA of the fiber (θ_{c0}) or more satisfies the total reflection condition only if the light beam is incident on the periphery of the fiber, and the light beam incident on the periphery of the fiber remains localized around the periphery of the fiber. As a result, a light beam incident on the fiber at an angle equal to or greater than the NA of the fiber propagates through the fiber and then remains localized around the periphery of the fiber.

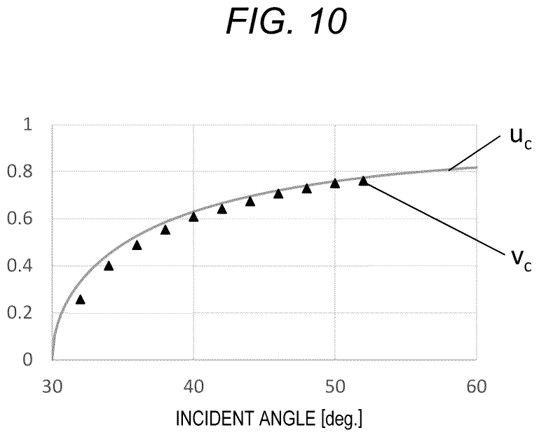

The diameter of the pinhole in the present embodiment will be explained. Based on the simulation result of the light intensity distributions of light on the emitting end of the fiber, illustrated in FIG. 6, with the light having become incident at angles of θ_{c0} or greater, the radius of the central area with the zero intensity is obtained for each of the incident angles. FIG. 10 illustrates a result comparing the incident angle dependency of v_{c} and u_{c} on the incident angle. The value v_{c} herein is obtained by normalizing the radius of the area where the intensity distribution is zero on the emitting end of the fiber with the radius c/2 of the fiber core, whereas u_{c} is as expressed by Mathematical Expression 11. It can be seen that both are almost the same.

Based on the above, it can be said that the light incident at an angle of θ_{c0} or greater is localized in the area outside of a radius cu_{c}/2 on the emitting end of the fiber. Therefore, denoting the angle of the crosstalk component to be eliminated incident to the fiber as φ (>θ_{c0}), the crosstalk component can be eliminated by setting the radius rₚ of the pinhole as follows.

$$\begin{matrix}[ Mathematical expression 16 ] & \\ {r}_{p} \leq \frac{c}{2} \sqrt{1 - {( \frac{NA}{sin ∅} )}^{2}} ( \vert ∅ \vert > \vert {θ}_{c 0} \vert ) & ( Mathematical expression 16 )\end{matrix}$$

There are two types of crosstalk one type of which is a component directly becoming incident on an adjacent fiber (hereinafter, referred to as a direct component), and the other type of which is a component reflected by the adjacent capillary and then becoming incident on the adjacent fiber, as indicated by the broken lines in FIG. 3. Because the intensity of the latter component is attenuated by being reflected, the direct component is more dominant, when there is any. Approximation of the minimum angle φₘᵢₙ at which the direct component illustrated in FIG. 3 becomes incident on the fiber is expressed by the following mathematical expression.

$$\begin{matrix}[ Mathematical expression 17 ] & \\ {∅}_{min} = {tan}^{- 1} ( \frac{p - \frac{c}{2}}{d - \frac{{D}_{out}}{2}} ) & ( Mathematical expression 17 )\end{matrix}$$

Where p denotes the interval between the capillaries (the distance between the centers of the capillaries), d denotes the distance from the surface of the capillary to the incoming end of the fiber, and Dₒᵤₜ denotes the outer diameter of the capillary, as indicated in FIG. 3. For simplicity, it is assumed that the fluorescence is generated at the center of the capillary.

For example, when p=500 μm, d=300 μm, Dₒᵤₜ=150 μm, and c=400 μm (that are the simulation conditions in the reference example in FIG. 5 where c=400 μm), φₘᵢₙ≈ 53 degrees, and assuming the case of the equal sign in Mathematical Expression 16, the pinhole radius rₚ corresponding to this incident angle is about 156 μm. In other words, by setting the pinhole radius to about 156 μm, it is possible, in principle, to block the entire direct crosstalk components while minimizing the loss of the signal component.

### [Second Embodiment] (Providing Imaging Optical System)

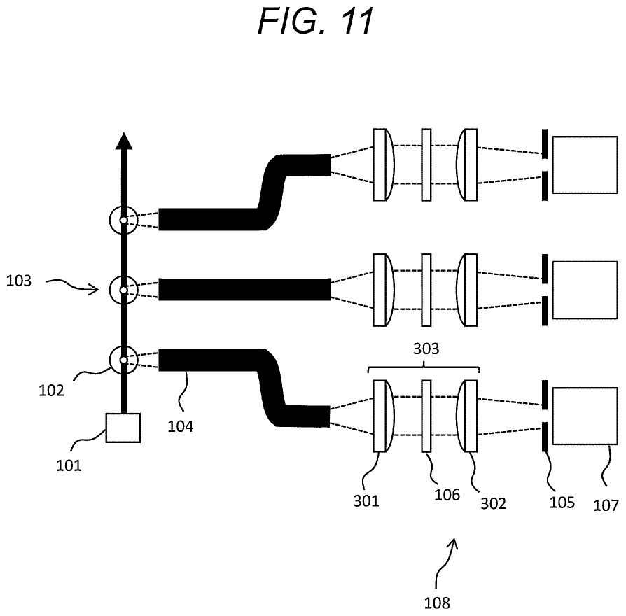

FIG. 11 is a schematic diagram illustrating a configuration example of a component detector 6 in a capillary electrophoresis device 1 according to the present embodiment. Components that are the same as those illustrated in FIG. 2 are denoted by the same reference numerals, and the descriptions thereof will be omitted. The present embodiment is different from the first embodiment in that the light detection unit 108 further includes an imaging optical system 303 that includes lenses 301, 302.

In the same manner as in the first embodiment, the plurality of capillaries 102 are irradiated with the excitation light emitted from the light source 101 in the direction in which the capillary array 103 is arranged, and a part of the fluorescence generated from the sample in each of the capillaries 102 is coupled to the detection optical fiber 104 provided correspondingly to the capillary 102. The fluorescence propagates through the detection optical fiber 104 and then goes out into the space, is converted into parallel light by the lens 301, passes through the longpass filter 106, and is then condensed by the lens 302 to the position of the pinhole 105. The pinhole 105 blocks the light emitted from the periphery of the emitting end of the detection optical fiber 104. As a result, the light emitted from the central portion of the emitting end of the detection optical fiber 104 is detected by the photodetector 107.

As described above, the light detection unit 108 according to the present embodiment includes the imaging optical system 303 that forms the image of the light output from the emitting end of the detection optical fiber 104, at the position of the pinhole 105.

In the present embodiment, because the imaging optical system 303 is provided to convert the light emitted from the detection optical fiber 104 into the parallel light, the light is enabled to become incident on the longpass filter 106 substantially perpendicularly. Therefore, it is possible to suppress performance deteriorations (e.g., an increased transmittance for the excitation light or a reduced transmittance for the fluorescence) resultant of the light becoming incident on the longpass filter 106 at an angle deviating from the right angle.

In addition, by setting the imaging magnification of the imaging optical system 303 to one or higher, that is, by forming a magnified image of the light output from the emitting end of the detection optical fiber 104 at the position of the pinhole, it is possible to relax the manufacturing accuracy or positional accuracy required for the hole diameter of the pinhole 105.

### [Third Embodiment] (Using Connection Optical Fiber)

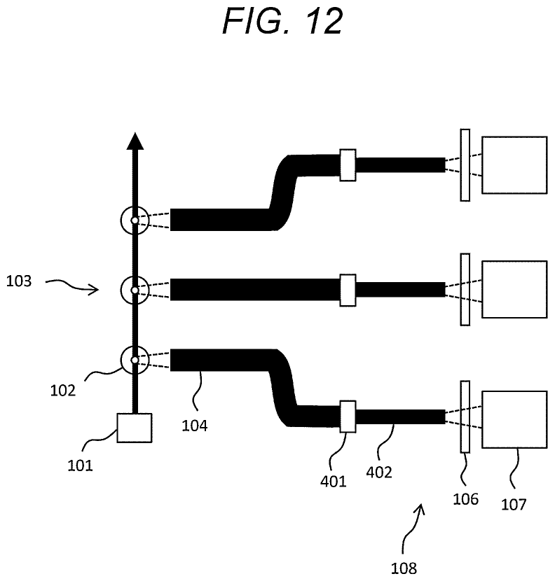

FIG. 12 is a schematic diagram illustrating a configuration example of a component detector 6 in a capillary electrophoresis device 1 according to the present embodiment. Components that are the same as those illustrated in FIG. 2 are denoted by the same reference numerals, and the descriptions thereof will be omitted. The present embodiment is different from the first embodiment in that the light detection unit 108 includes a fiber connector 401, a connection optical fiber 402, the longpass filter 106 and the photodetector 107.

In the same manner as in the first embodiment, the plurality of capillaries 102 are irradiated with the excitation light emitted from the light source 101 in the direction in which the capillary array 103 is arranged, and a part of the fluorescence generated from the sample in each of the capillaries 102 is coupled to the detection optical fiber 104 provided correspondingly to the capillary 102. The fluorescence propagates through the detection optical fiber 104 and then is coupled to the connection optical fiber 402 connected to the detection optical fiber 104 via the fiber connector 401.

The core diameter of the connection optical fiber 402 is set smaller than the core diameter of the detection optical fiber 104, and only the light in proximity of the center of the emitting end of the detection optical fiber 104 is coupled to and propagates through the connection optical fiber 402, and guided to the photodetector 107. In other words, the connection optical fiber 402 plays a role equivalent to that of the pinhole 105 in the first embodiment. At this time, the central axes of the detection optical fiber 104 and the connection optical fiber 402 are positioned in a manner matching each other, via the fiber connector 401 that is a general-purpose component. As a result, in the present embodiment, the alignment of the central axes of the detection optical fiber 104 and the pinhole 105, which is required in the first embodiment, is rendered unnecessary, and the same performance as that achieved by the first embodiment can be achieved more easily.

It is also possible to combine the imaging optical system 303 (FIG. 11) according to the second embodiment with the connection optical fiber 402 (FIG. 12) according the third embodiment. For example, the imaging optical system 303 may be used in FIG. 12, in replacement of the fiber connector 401. In such a configuration, the imaging optical system 303 forms an image of the light output from the emitting end of the detection optical fiber 104, on the incoming end of the connection optical fiber 402.

In such a combination, by setting the imaging magnification of the imaging optical system 303 to one or higher, that is, by magnifying the image, the degree of freedom in the core diameter of the connection optical fiber 402 is increased. For example, the core diameter of the connection optical fiber 402 may be set equal to or larger than the core diameter of the detection optical fiber 104.

### [Fourth Embodiment] (Using Imaging Device)

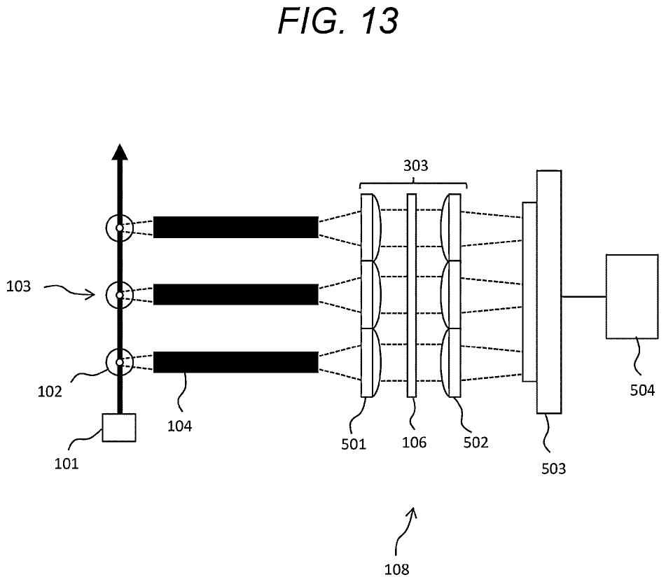

FIG. 13 is a schematic diagram illustrating a configuration example of a component detector 6 in a capillary electrophoresis device 1 according to the present embodiment. Components that are the same as those illustrated in FIG. 2 are denoted by the same reference numerals, and the descriptions thereof will be omitted. The present embodiment is different from the first embodiment in that the light detection unit 108 includes an imaging optical system 303 (including micro-lens arrays 501, 502), the longpass filter 106, an imaging device 503, and a signal processing unit 504.

In the same manner as in the first embodiment, the plurality of capillaries 102 are irradiated with the excitation light emitted from the light source 101 in the direction in which the capillary array 103 is arranged, and a part of the fluorescence generated from the sample in each of the capillaries 102 is coupled to the detection optical fiber 104 provided correspondingly to the capillary 102. The imaging optical system 303 plays a role for forming images of the light emitted from the emitting ends of all of the detection optical fibers 104 on the imaging device 503 (more precisely, on a light receiving unit thereof, for example), whereby allowing the imaging device 503 to detect the two-dimensional light intensity distribution of the fluorescence output from the detection optical fiber 104, and to transfer the light intensity distribution to the signal processing unit 504.

The signal processing unit 504 processes the light in the central portion of the detection optical fiber 104 selectively, among the light detected by the imaging device 503. For example, only the intensities of light in the central portion are obtained as signals and the sum thereof is calculated, while ignoring the intensities of the light in the other portion. In other words, in the present embodiment, the signal processing unit 504 plays the role of the pinhole 105 in the first embodiment.

In the present embodiment, it is possible to suppress crosstalk only by means of the signal processing, without providing a pinhole or a connection optical fiber. In addition, because the size of the detection area can be freely set by the signal processing unit 504, the magnitude relationship between the signal intensity and the crosstalk is made more optimizable depending on its application.

As described above, the following description is applicable to the various embodiments of the present invention.

One example of the present invention is a capillary electrophoresis device including:
a light source;
a plurality of capillaries;
a light detection unit; and
a plurality of detection optical fibers each having one end face disposed in association with corresponding one of the capillaries and another end face connected to the light detection unit,
wherein the light detection unit selectively detects light in a central portion of the detection optical fiber.

With such a configuration, it is possible to suppress crosstalk.

As an example, the light detection unit may include at least a photodetector and a selective light shielding element.

With such a configuration, it is possible to suppress crosstalk using an inexpensive and simple configuration.

As an example, the light detection unit may include at least a photodetector and a connection optical fiber.

With such a configuration, it is possible to suppress crosstalk using a structure, stably.

As an example, the light detection unit may include at least an imaging device and a signal processing unit, and the signal processing unit may process the light in the central portion of the detection optical fiber selectively, among light detected by the imaging device.

With such a configuration, it is possible to suppress crosstalk only with the signal processing unit, without using any light shielding component.

As an example, the light detection unit may further include an imaging optical system that forms an image of light output from the emitting end of the detection optical fiber at a position of the selective light shielding element.

With such a configuration, components such as an optical filter can be arranged more easily, and robustness against positional deviation of the selective light shielding element can be improved by appropriately setting the imaging magnification.

As an example, the light detection unit may further include an imaging optical system that forms an image of light output from an emitting end of the detection optical fiber on an incoming end of the connection optical fiber.

With such a configuration, components such as an optical filter can be arranged more easily, and robustness against positional deviation of the connection optical fiber can be improved by appropriately setting the imaging magnification.

As an example, the connection optical fiber may have a core diameter smaller than the core diameter of the detection optical fiber.

With such a configuration, the need for a pinhole is eliminated.

As an example, the light detection unit may further include an imaging optical system that forms an image of light emitted from an emitting end of the detection optical fiber on the imaging device.

With such a configuration, components such as an optical filter can be arranged more easily, and the crosstalk suppression effect by the signal processing can be improved by appropriately setting the imaging magnification.

As an example, the light detection unit selectively detects only light in an area of a radius r or less from a center at an emitting end of the detection optical fiber,
where r is given by the following mathematical expression:

$$[ Mathematical expression 18 ]$$

$$r = \frac{c}{2} \sqrt{1 - {( \frac{NA}{sin ∅} )}^{2}} ( \vert ∅ \vert > \vert {sin}^{- 1} NA \vert ) \\ ∅ = {tan}^{- 1} ( \frac{p - \frac{c}{2}}{d - \frac{{D}_{out}}{2}} )$$

where NA may be a numerical aperture of the detection optical fiber,
c may be a core diameter of the detection optical fiber,
p may be an interval between the plurality of capillaries,
Dₒᵤₜ may be an outer diameter of the capillary, and
d may be a distance from a surface of the capillary to an incoming end of the corresponding detection optical fiber.

With such a configuration, it is possible to suppress the crosstalk while minimizing the loss of the signal component.

As an example, the light detection unit may be capable of changing at least one of an area or a shape of a selectively detected area of the detection optical fiber.

With such a configuration, the detection sensitivity and the crosstalk can be adjusted as appropriate, depending on the application.

### REFERENCE SIGNS LIST

1 capillary electrophoresis device
2 electrophoresis medium container
3 sample container
4 inlet-side electrode vial
5 capillary
6 component detector
7 outlet-side electrode vial
8 high-voltage power supply
9 electrode
11 capillary array
101 light source
102 capillary
103 capillary array
104 detection optical fiber
105 pinhole (selective light shielding element)
106 longpass filter
107 photodetector
108 light detection unit
201, 202 capillary
203, 204 detection optical fiber
301, 302 lens
303 imaging optical system
401 fiber connector
402 connection optical fiber
501 microlens array
503 imaging device
504 signal processing unit

1. A capillary electrophoresis device comprising:
a light source;
a plurality of capillaries;
a light detection unit; and
a plurality of detection optical fibers each having one end face disposed in association with corresponding one of the capillaries and another end face connected to the light detection unit,
wherein the light detection unit selectively detects light in a central portion of the detection optical fiber.

2. The capillary electrophoresis device according to claim 1, wherein the light detection unit includes at least a photodetector and a selective light shielding element.

3. The capillary electrophoresis device according to claim 1, wherein the light detection unit includes at least a photodetector and a connection optical fiber.

4. The capillary electrophoresis device according to claim 1, wherein
the light detection unit includes at least an imaging device and a signal processing unit, and
the signal processing unit processes light in a central portion of the detection optical fiber selectively, among light detected by the imaging device.

5. The capillary electrophoresis device according to claim 2, wherein the light detection unit further includes an imaging optical system that forms an image of light emitted from an emitting end of the detection optical fiber at a position of the selective light shielding element.

6. The capillary electrophoresis device according to claim 3, wherein the light detection unit further includes an imaging optical system that forms an image of light emitted from an emitting end of the detection optical fiber on an incoming end of the connection optical fiber.

7. The capillary electrophoresis device according to claim 3, wherein the connection optical fiber has a core diameter smaller than a core diameter of the detection optical fiber.

8. The capillary electrophoresis device according to claim 4, wherein the light detection unit further includes an imaging optical system that forms an image of light emitted from an emitting end of the detection optical fiber on the imaging device.

9. The capillary electrophoresis device according to claim 1, wherein
the light detection unit selectively detects only light in an area of a radius r or less from a center at an emitting end of the detection optical fiber, and
r is given by a following mathematical expression:
$$[ Mathematical expression 1 ]$$
$$r = \frac{c}{2} \sqrt{1 - {( \frac{NA}{sin ∅} )}^{2}} ( \vert ∅ \vert > \vert {sin}^{- 1} NA \vert ) \\ ∅ = {tan}^{- 1} ( \frac{p - \frac{c}{2}}{d - \frac{{D}_{out}}{2}} )$$
NA is a numerical aperture of the detection optical fiber,
c is a core diameter of the detection optical fiber,
p is an interval between the plurality of capillaries,
Dₒᵤₜ is an outer diameter of the capillary, and
d is a distance from a surface of the capillary to an incoming end of the corresponding detection optical fiber.

10. The capillary electrophoresis device according to claim 1, wherein the light detection unit is capable of changing at least one of an area or a shape of a selectively detected area of the detection optical fiber.
